(19) United States
(12) Patent Application Publication
(10) Pub. No.: US 2020/0272377 A1
(43) Pub. Date: Aug. 27, 2020

(54) METHOD AND APPARATUS FOR SECURING PERIPHERAL DEVICES

(71) Applicant: VIDEOJET TECHNOLOGIES INC., Wood Dale, IL (US)

(72) Inventor: Steven John Buckby, Nottingham (GB)

(21) Appl. No.: 16/646,314

(22) PCT Filed: Sep. 7, 2018
(86) PCT No.: PCT/GB2018/052540

§ 371 Date: Mar. 11, 2020

(30) Foreign Application Priority Data
Sep. 11, 2017 (GB) 1714555.8

(51) Int. Cl. G06F 3/12; G06F 21/60

(52) U.S. Cl. CPC G06F 3/1222; G06F 21/608; G06F 3/1238; G06F 21/85; G06F 3/1239; G06F 3/1285; G06F 3/1232

(57) ABSTRACT

A printing machine 1 comprises a processor (2a) and a memory (2b, 2c) storing computer readable instructions. The computer readable instructions are arranged to cause the processor (2a) to generate access request data for processing by an access control server (3), receive access response data responsive to the access request data, process the access response data to determine a first print type and a first print quantity indicated by the access response data, and update, responsive to processing the access response data, an access status in the memory to indicate a second print quantity for the first print type.

The present invention relates to the securing of peripheral devices such as printing machines through the control of access rights.

It may be desirable to securely and controllably restrict the ability to use printing machines, for example where printing machines may be placed at locations in which sensitive material may be circulated. Further, a printing machine is generally capable of executing print jobs which are of different print types, and different print types often require different resources. It may be further desirable to restrict the ability to use printing machines for executing different print types, in order to allow efficient use of the resources available to the printing machines and to reduce unnecessary waste.

It is an object of at least some embodiments of the present invention to provide a new way to secure printing machines or to obviate or mitigate one or more problems of the prior art.

According to a first aspect of the present invention, there is provided a printing machine. The printing machine comprises a processor, and a memory storing computer readable instructions arranged to cause the processor to: generate access request data for processing by an access control server; receive access response data responsive to the access request data; process the access response data to determine a first print type and a first print quantity indicated by the access response data; and update, responsive to processing the access response data, an access status in the memory to indicate a second print quantity for the first print type.

By generating access request data and receiving access response data at the printing machine and arranging the access response data to be indicative of a first print type and a first print quantity, the access response data may be used to grant access to a printing function of the printing machine for executing print job(s) which are of the first print type within the first print quantity. In this way, access to various printing functions of the printing machine with regard to different print types can be securely controlled. Further, since different print types generally require different resources, controlling the access to the printing machine with regard to different print types allows efficient use of the resources available to the printing machine and reduces unnecessary waste.

The first print type may be at least one of a layout template, a print width, a number of character(s) contained within a print unit, or a type of ink.

The first print quantity may be at least one of a print distance, a length of ribbon, a number of pages, a number of print units, or a quantity of ink.

The first print quantity may be quantized to an integer multiple of a unit print quantity.

The access request data may comprise information indicative of a second print type.

The second print type may be the same as the first print type.

The computer readable instructions may be arranged to cause the processor to encrypt and/or cryptographically sign the access request data.

The computer readable instructions may be arranged to cause the processor to include a unique identifier of the printing machine in the access request data.

The computer readable instructions may be arranged to cause the processor to process the access response data to verify that the access response data includes the unique identifier of the printing machine.

The access response data may be for granting the printing machine an access right for printing any material having the first print type within the first print quantity.

The access right granted to the printing machine by the access response data may be independent of an identity of a user of the printing machine. That is, if the printing machine does not receive any access response data indicative of the first print type, the printing machine may not be able to print any material having the first print type, regardless of which user is using the printing machine.

In response to the processor verifying that the access response data does not include the unique identifier of the printing machine, the computer readable instructions may be arranged to cause the processor to discard the access response data without updating the access status in the memory.

To process the access response data, the computer readable instructions may be arranged to cause the processor to verify that the access response data originates at the access control server.

The computer readable instructions may be arranged to cause the processor to update the access status from indicating a third print quantity for the first print type to indicate the second print quantity for the first print type.

The computer readable instructions may be arranged to cause the processor to: receive a print request indicating material to be printed; determine a print type and a print quantity of the print request, and determine, based upon the access status stored in the memory, whether the print request can be executed in its entirety.

The print request may comprise information indicative of the print type of the print request.

In response to determine that the print request cannot be executed in its entirety, the computer readable instructions may be arranged to cause the processor to generate a further access request data for processing by the access control server.

To determine whether the print request can be executed in its entirety, the computer readable instructions may be arranged to cause the processor to: determine whether the access status stored in the memory comprises a first access status corresponding to the print type of the print request.

If the access status stored in the memory does not comprise the first access status, the computer readable instructions may be arranged to cause the processor to determine that the print request cannot be executed in its entirety.

The computer readable instructions may be arranged to cause the processor to: in response to determining that the access status stored in the memory comprises the first access status, compare a fourth print quantity corresponding to the first access status with the print quantity of the print request.

If the fourth print quantity is insufficient for satisfying the print quantity of the print request, the computer readable instructions may be arranged to cause the processor to determine that the print request cannot be executed in its entirety.

In response to determine that the print request cannot be executed in its entirety, the computer readable instructions may be arranged to cause the processor to deny the print request.

The computer readable instructions may be arranged to cause the processor to print only a part of the material to be printed, the part being determined based upon the access status.

The computer readable instructions may be arranged to cause the processor to update the access status to indicate a new print quantity corresponding to the print type of the print request in response to printing only a part of the material.

The access status stored in the memory may comprise a further access status corresponding to another print type which is different from the print type of the print request, and the computer readable instructions may be arranged to cause the processor to determine whether the print request can be executed in its entity, independently of the further access status.

The printing machine may be a thermal transfer printer.

Where the printing machine is a thermal transfer printer, each print type may be at least one of a layout template, a print width, or a number of character(s) contained within a print unit, and each print quantity may be at least one of a print distance or a length of ribbon.

According to a second aspect of the present invention, there is provided a system which comprises a print file control server comprising a first server processor and a memory storing computer readable instructions arranged to cause the first server processor to: receive an indication of material to be printed; determine a print type of the material to be printed; and generate a print file for receipt by a printing machine, the generated print file comprising the material to be printed and information indicative of the print type of the material to be printed.

The print file may further include information indicative of a print quantity of the material to be printed.

The computer readable instructions may be arranged to cause the first server processor to: generate print consumables request data, wherein the print consumables request data includes information indicative of a type of print consumables for provision to the printing machine.

The type of print consumables may correspond to the print type of the material to be printed.

In this way, the print consumables request data can be used to automatically order print consumables of a correct type suitable for use by the printing machine to execute the print file. The ordering of print consumables is therefore automated and does not require any user intervention.

The print consumables request data may include information indicative of an amount of print consumables for provision to the printing machine, the amount of print consumables being corresponding to the type of print consumables.

The computer readable instructions may be arranged to cause the first server processor to determine the amount of print consumables based upon the print quantity of the material to be printed.

In this way, it is ensured that the amount of print consumables requested by the print consumables request data is sufficient for the printing machine to execute the print quantity in its entirety. The first server processor determines the amount of print consumables further based upon the print type of the material to be printed.

The computer readable instructions may be arranged to cause the first server processor to: determine a consumption rate of print consumables of a type required by a printing machine based upon print files generated by the first server processor for receipt by the printing machine; and generate print consumables request data based upon the determined consumption rate, wherein the print consumables request data includes information indicative of the type of print consumables for provision to the printing machine.

The system may further comprise an access control server comprising a second server processor and a memory storing computer readable instructions arranged to cause the second server processor to: receive access request data requesting access to a printing function of a printing machine; process the access request data to determine an identifier of the printing machine; retrieve access control information from the memory based on the determined identifier; generate access response data indicating a first print type and a first print quantity, based upon the retrieved access control information; and update the access control information stored in the memory to indicate issuance of the access response data.

The print file control server may be configured to transmit the print consumables request data to the access control server.

The computer readable instructions may be arranged to cause the second server processor to: process the print consumables request data to authorise a shipping of print consumables to a printing machine, the print consumables being of a type indicated by the print consumables request data.

The computer readable instructions may be arranged to cause the second server processor to encrypt and/or cryptographically sign the access response data.

The system may further comprise a user device comprising a user device processor and a memory storing computer readable instructions arranged to cause the user device processor to receive the access request data from the printing machine for onward transmission and to receive the access response data.

The system may further comprise a distributor device comprising a distributor device processor and a memory storing computer readable instructions arranged to cause the distributor device processor to: receive the access request data; and transmit the access request data to the access control server.

The instructions stored in the memory of the access control server may be arranged to cause the second server processor to determine, based on a distributor identifier in the access request data, that the request for access to the printing function may be granted.

The instructions stored in the memory of the distributor device may be arranged to cause the distributor device processor to: receive the access response data from the access control server; and to transmit the access control data to the printing machine.

The system may further comprise a printing machine according to the first aspect of the invention.

According to a third aspect of the invention, there is provided a method for controlling access to a printing function of a printing machine. The method comprises, at the printing machine: generating access request data for processing by an access control server; receiving access response data responsive to the access request data; processing the access response data to determine a first print type and a first print quantity indicated by the access response data; and updating, responsive to processing the access response data, an access status in the memory to indicate a second print quantity for the first print type.

According to a fourth aspect of the invention, there is provided a computer readable medium carrying computer readable instructions arranged to cause a processor to carry out a method according to the third aspect of the invention.

According to a fifth aspect of the invention, there is provided a method for generating a print file for provision to a printing machine. The method comprises: receiving an indication of material to be printed; determining a print type of the material to be printed; and generating a print file for provision to the printing machine, the generated print file comprising the material to be printed and information indicative of the print type of the material to be printed.

The method may further comprise: generating a print consumables request data based on the print type and an indication of a print quantity associated with the print type; and providing the print consumables request data to a server.

The method may further comprise processing the print consumables request data by the server to automatically order print consumables for the printing machine.

According to a sixth aspect of the invention, there is provided a computer readable medium carrying computer readable instructions arranged to cause a processor to carry out a method according to the fifth aspect of the invention.

Where features have been described above in the context of one aspect of the invention, it will be appreciated that where appropriate such features may be applied to other aspects of the invention. Indeed, any of the features described above and elsewhere herein can be combined in any operative combination and such combination is expressly foreseen in the present disclosure.

To the extent appropriate, methods described herein may be implemented by way of suitable computer programs and as such computer programs comprising processor readable instructions arranged to cause a processor to execute such control methods are provided. Such computer programs may be carried on any appropriate carrier medium (which may be a tangible or non-tangible carrier medium).

Embodiments of the invention are now described, by way of example only, with reference to the accompanying drawings, in which:

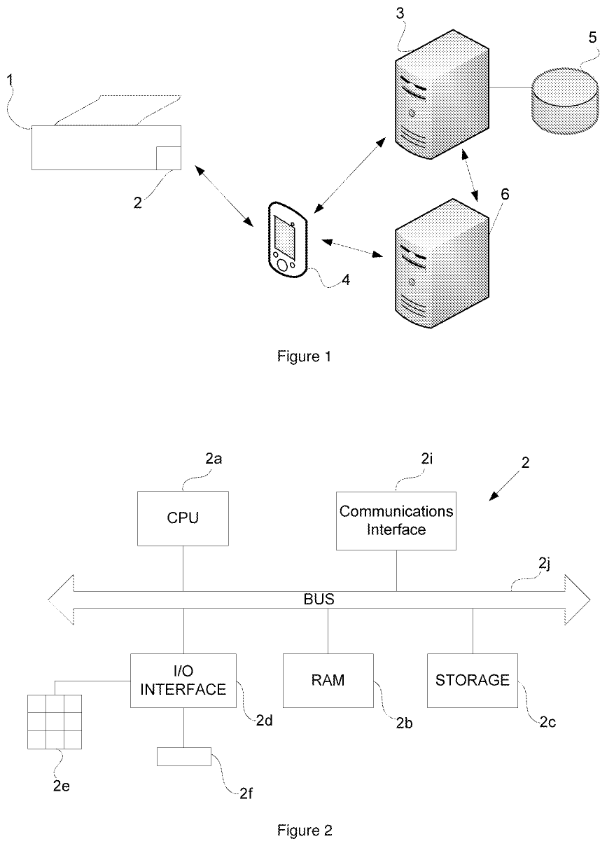

FIG. 1 is a schematic illustration of an access control system comprising a printing machine according to an embodiment of the invention;

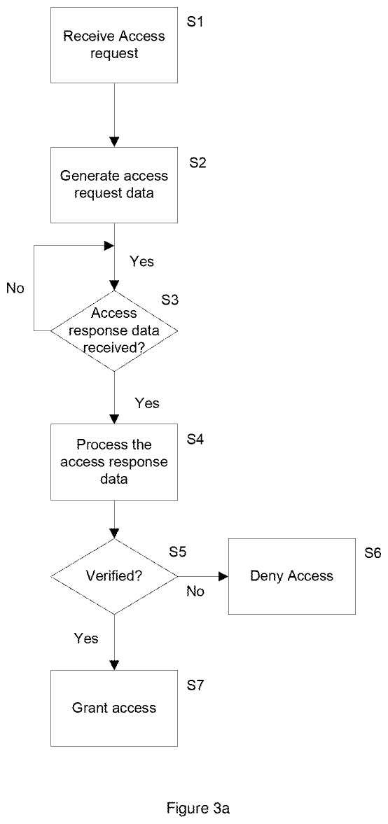

FIG. 2 is a schematic illustration of exemplary components that may be provided by the printing machine of FIG. 1;

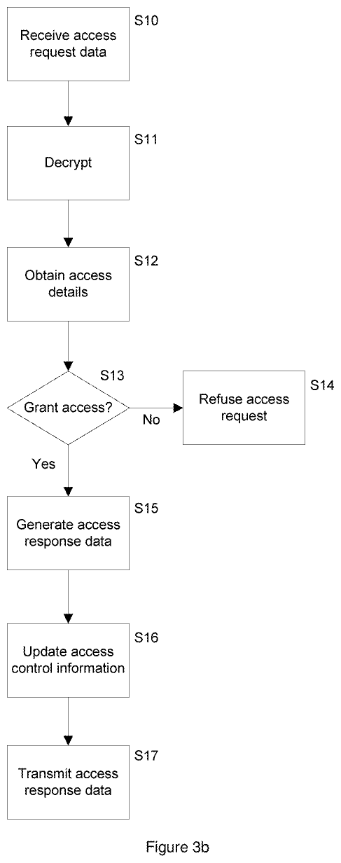

FIG. 3a is a flowchart showing processing that may be carried out by the printing machine of FIG. 1;

FIG. 3b is a flowchart showing processing that may be carried out by an access control server of FIG. 1.

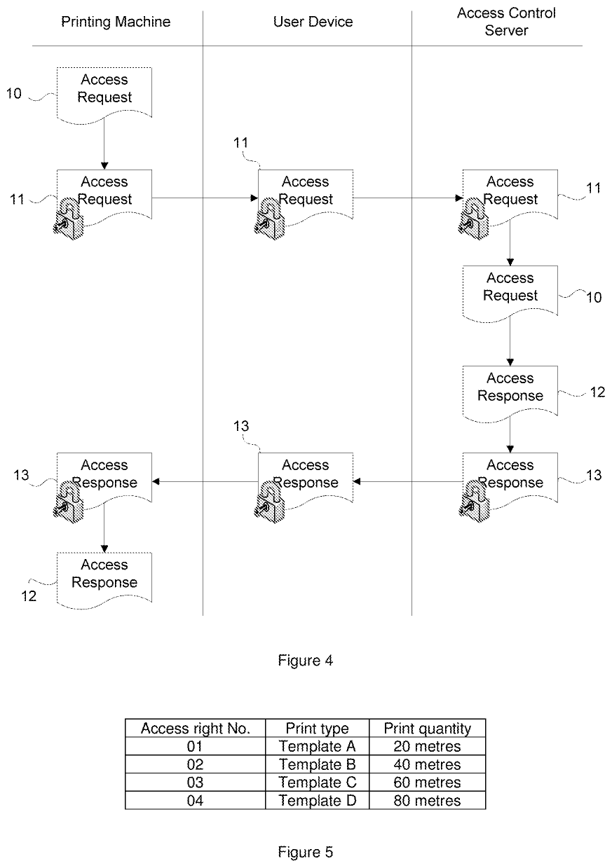

FIG. 4 schematically illustrates data transfers between components of the access control system in accordance with an example embodiment;

FIG. 5 schematically illustrates a format of access rights stored within the printing machine of FIG. 1.

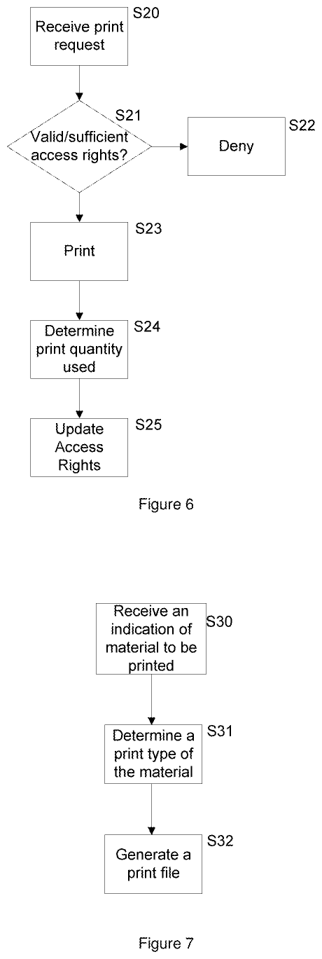

FIG. 6 is a flowchart showing processing that may be carried out by the printing machine of FIG. 1 upon receiving a print request.

FIG. 7 is a flowchart showing processing that may be carried out by a print file control server of FIG. 1.

FIG. 1 schematically illustrates a printing machine 1. The printing machine 1 has printing functions to which it is desired to control access. The printing machine 1 is provided with a controller 2. It will be appreciated that reference below to processing operations being performed by the printing machine 1 may be performed by the controller 2.

FIG. 2 schematically illustrates components of the controller 2 of the printing machine 1 in accordance with an exemplary embodiment. It can be seen that the controller 2 comprises a CPU 2a which is configured to read and execute instructions stored in a RAM memory 2b which may be a volatile memory. The RAM 2b stores instructions for execution by the CPU 2a and data used by those instructions. For example, instructions may be provided to control a printing function of the printing machine 1. Further instructions may be provided to cause the controller 2 to perform actions to control access to printing functions of the printing machine 1.

The controller 2 further comprises non-volatile storage 2c, such as, for example, a hard disk drive, although it will be appreciated that any other form of non-volatile storage may be used. Computer readable instructions for controlling printing functions and for controlling access to printing functions of the printing machine 1 may be stored in the non-volatile storage 2c. The controller 2 further comprises an I/O interface 2d to which peripheral devices used in connection with the printing machine 1 may be connected. For example, an input 2e (shown in the form of a keypad) may be provided to allow user interaction with the printing machine 1. While not shown, it will be appreciated that other input or output devices may be connected to the I/O interface, such as a display. In other embodiments, however, the printing machine 1 may not be provided with means for a user to interact directly with the printing machine 1. Interaction with the printing machine 1 may be entirely through a connected device.

The I/O interface 2d may further comprise a port 2f to allow the connection of I/O devices, such as data storage devices. For example, the port 2f may be a USB port to allow connection of USB flash drives. A communications interface 2i may also be provided. The communications interface 2i may provide for short range connections to other devices (e.g. via Bluetooth, near-field communication (NFC), etc.), and/or for connection to networks such as the Internet, for longer range communication. The CPU 2a, RAM 2b, non-volatile storage 2c, I/O interface 2d and communications interface 2i are connected together by a bus 2j.

It will be appreciated that the arrangement of components illustrated in FIG. 2 is merely exemplary, and that the controller 2 may comprise different, additional or fewer components than those illustrated in FIG. 2. Additionally, it will be appreciated that the printing machine 1 will comprise other components for performing printing functions which are not illustrated in FIG. 2.

Referring again to FIG. 1, the printing machine 1, through the controller 2, is configured to communicate with an access control server 3. In the embodiment of FIG. 1, the printing machine 1 is configured to communicate with the access control server 3 via a user device 4. In FIG. 1 the user device 4 is depicted in the form of a mobile computing device such as a smartphone. It will be understood, however, that the user device 4 may take any form. For example, the user device 4 may be a desktop computer, a laptop computer or a server. The printing machine 1 may be arranged to communicate with the user device 4 via any means. For example, the printing machine 1 may have a wired connection to the user device 4 (such as a USB connection). The printing machine 1 may connect to the user device 4 over a wireless connection. Such a wireless connection may use a short range communications protocol such as Bluetooth, for example. The user device 4 is arranged to communicate with the access control server 3 via suitable networks, such as the Internet.

Further, as shown in FIG. 1, the printing machine 1 is configured to communicate with a print file control server 6 via the user device 4. The user device 4 is arranged to communicate with the print file control server 6 via suitable networks, such as the Internet. The print file control server 6 is arranged to communicate with the access control server 3 via suitable networks, such as the Internet. It is to be understood, however, that the arrangement of FIG. 1 is merely exemplary and alternative arrangements are possible. For example, two separate user devices may be employed to communicate with the access control server 3 and the print file control server 6 respectively.

In other embodiments, for example, the printing machine 1 may be configured to communicate directly with the access control server 3 and/or the print file control server 6. In further alternative embodiments, the printing machine 1 may not comprise a suitable interface for direct connection and communication with the user device 4. In such a case, communication between the printing machine 1 and the user device 4 may be through the manual transfer of files. For example, data may be provided to, and received from, the printing machine 1 via external storage devices which may connect to the port 2f.

The access control server 3 is configured to maintain access control information for the printing machine 1 in a database 5. The access control server 3 may maintain access control information for each of a plurality of printing machines and/or other devices. As is described in more detail below with reference to FIGS. 3 to 6, the controller 2 and the access control server 3 operate together to control access to printing functions of the printing machine 1.

The print file control server 6 is configured to generate a print file for provision to the printing machine 1. The generated print file includes material to be printed and information indicative of a print type of the material. For example, the material to be printed may comprise image data, textual data or a combination of image and text data. After receiving the generated print file, the printing machine 1 may be requested by a user to print the material to be printed. The controller 2 may use the information indicative of a print type of the material to control whether a relevant printing function of the printing machine 1 can be accessed to execute the print file. Further, the print file control server 6 may be configured to generate print consumables request data based upon the print file for provision to the access control server 3. The print consumables request data may be used to automatically order print consumables of a type suitable for use by the printing machine 1 to execute the print file. The processing performed by the print file control server 6 is described in more detail below with reference to FIG. 7.

Processing that is performed by the controller 2 is now described in more detail, with reference to FIG. 3a. At step S1 the controller 2 receives an access request from a potential user of the printing machine 1—i.e., someone who wishes to use a printing function of the printing machine 1. The access request may take any suitable form and the controller 2 may receive the access request in any suitable manner. Indeed, it will be appreciated from the above that the manner in which the controller 2 receives the access request may vary in dependence upon the functionality and communications capabilities of the controller 2. For example, where the controller 2 provides user input means (such as the key pad 2e) a user may interact directly with the printing machine 1 to input an access request. In other embodiments, the user may interact with the controller 2 through the user device 4. The user device 4 may connect to the controller 2 via any suitable means, such as Bluetooth or near-field communication (NFC). In this way, a suitable user interface may be provided on the user device 4 to allow the user to interact with the printing machine 1 and to provide the access request. The user device 4 may, for example, run a local application, or access a remotely hosted application (e.g. a “web application”), that allows the user device 4 to communicate with the controller 2.

In an embodiment, for example, the access request may include information indicative of a print type requested by the potential user. A print type may be a type of print job intended to be printed by the potential user. For example, if the user creates a design of a print job using a particular layout template and wishes to use the print machine 1 to execute the print job, then the print type may be indicative of the particular layout template. In another example, the print job may have a particular print width. That is, the user may wish the print job to be printed on a substrate as an object having a width equal to the particular print width. The print width may therefore be regarded as a print type. In a further example, if the print job includes a plurality of print units, then the print type may be a print width of each print unit or a number of characters contained in each print unit. Where the printing machine 1 is an inkjet printer, the print type may be defined by a type of ink to be used. One access request is generally associated with a single print type requested by the potential user, but may be associated with more than one print type in some embodiments. The print type indicated by the access request may be selected from a predetermined group of print types. The access request may further include information indicative of a print quantity requested by the potential user for each print type. The print quantity may be measured in any appropriate unit, such as, a print distance, a length of ribbon, a number of pages, a number of print units, or a quantity of ink. Alternatively, the access request received by the controller 2 at step S1 may not include any information indicative of a print type and/or a print quantity requested by the potential user. Instead, that information may be directly provided from the potential user to the access control server 3, as described in more detail below.

The access request may include additional information relating to the intended use of the printing machine 1. For example, the access request may specify additional details such as a time period, an identifier of the particular user making the access request, or any other details which may be required in a particular application to make a decision as to whether the access request should be granted. The access request may have any appropriate format.

In response to receiving the access request at step S1, the processing then proceeds to step S2 where the controller 2 generates an access request file for processing by the access control server 3. The access request file includes a unique identifier of the printing machine 1. The access request file may be in any format and may comprise a plurality of files.

In an embodiment, the access request file may include information indicative of a print type and a print quantity requested by the potential user, if, for example, that information is contained within the access request received at step S1 or subsequently provided. The information indicative of the print type and the print quantity contained within the access request file may take a different format from that of the corresponding information contained within the access request received at step S1. For example, the controller 2 may translate or map the print type and the print quantity determined at step S2 to corresponding binary codes known by both the controller 2 and the access control server 3, for the ease of subsequent data communication.

In an alternative embodiment, the access request file may not include information indicative of a print type or a print quantity requested by the potential user. The information indicative of the print type and the print quantity may be provided from the potential user directly to the access control server 3 without the printing machine 1. For example, the potential user may utilise the user device 4 to run a local application, or access a remotely hosted application (e.g. a “web application”), that allows the user device 4 to communicate with the access control server 3. During the communication between the user device 4 and the access control server 3, the potential user may operate the user device 4 to transmit information indicative of a print type and a print quantity to the access control server 3. The potential user may select the print type and the print quantity to be requested separately, for example by inputting suitable parameters into the local application or the web application at the user device 4. The information indicative of a print type and a print quantity may be transmitted together with the access request file by the user device 4 to the access control server 3, if the access request file is available to the user device 4. Alternatively, the information indicative of a print type and a print quantity may be transmitted by the user device 4 to the access control server 3 separately from the access request file. In that case, the information may quote a unique number (e.g., a reference number) of the access request file generated at step S2, so as to allow the access control server 3 to associate the information with the access request file.

In a further embodiment, information indicative of a print type may be provided to the access control server 3 as part of the access request file generated at step S2, or may be provided by the user device 4 to the access control server 3 as described above without information indicative of a print quantity being contained within the access request file. For example, the information indicative of a print quantity may be provided manually by the potential user to an administrator of the access control server 3 via suitable communication means (such as, email, telephone or facsimile), and the administrator may manually enter the information into the access control server 3.

The access request file may include additional information relating to the access request such as a time of the access request and any other information required by the access control server 3 to determine whether to grant the access request. The access control file may be encrypted by the controller 2. For example, the controller 2 may utilise an asymmetric encryption algorithm with the access control file encrypted using a public key of the access control server 3. In this way only the access control server 3 can decrypt the access control file using its private key. The controller 2 may additionally or alternatively cryptographically sign the access control file using its private key to allow the access control server 3 to verify that the controller 2 is the source of the access request file (by decrypting the signature using the public key of the printing machine 1/controller 2). Any appropriate public key algorithms may be used, such as RSA. Other methods of encryption and verification, such as symmetric key algorithms, may also be used as will be apparent to the skilled person. It is to be understood that while described as a “file” herein for clarity and convenience, the access request may take any appropriate form and may be a plurality of files. The access request file may therefore, more generally, be access request data.

The processing of FIG. 3a proceeds to step S3 where the controller 2 awaits a response to the access request file, in the form of an access response file, from the access control server 3. While an access response file has not been received, processing loops at step S3. The processing may loop at step S3 for any amount of time, e.g., hours, days, etc., during which the controller 2 and the printing machine 1 may be able to perform other tasks. For example, while the processing loops at step S3, the same potential user or a different user may continue to use the printing machine 1 to execute print request(s) (as described in more detail with reference to FIG. 6), and the controller 2 may receive further access request(s) from potential users and generate further access request file(s) for processing by the access control server 3.

Turning to FIG. 3b, processing performed by the access control server 3 is now described. At step S10 the access control server 3 receives the access request file generated by the controller 2. The access request file may be provided to the access control server 3 via any appropriate mechanism. For example, where the printing machine 1 is connected to the access control server 3 via a network, the printing machine 1 may transmit the access request file to the access control server 3. Alternatively, the access request file may be provided to the user for onward transmission to the access control server 3. For example, the access request file may be saved by the controller 2 to an external storage device (such as a USB flash drive) for the user to transfer the file to the user device 4, or may be directly transmitted from the controller 2 to the user device 4 (for example, via Bluetooth). The access request file may then be transmitted from the user device 4 to the access control server 3 using any appropriate mechanism. In one embodiment, a user of the user device 4 may use a general electronic communication application running on the user device 4 (such as an email client) to send the access request file to the access control server 3 (i.e., to an email account accessible to software operating on the access control server 3). As an alternative example, where an access control application runs on the user device 4, the access control application may be arranged to communicate with the access control server 3. It will be understood that where the access request file does not contain information indicative of a print type or a print quantity requested by the potential user, the access control server 3 also receives that information at step S10, from, for example, the user device 4 or an administrator of the access control server 3.

Upon receipt of the access request file at the access control server 3 at step S10, processing passes to step S11 to obtain the identifier of the printing machine 1, and any other information which is contained in the access request file. For example, where the access request file is encrypted, the access control server 3 may decrypt the access request file at step S11. Where the access request file includes a signature, the access control server 3 may verify the signature to determine that the source of the access request file is the printing machine 1/controller 2. At step S12, the access control server 3 uses the identifier of the printing machine 1 to obtain access control information stored in the database 5. The database 5 may, for example, store an access status for the printing machine 1 with regard to at least one print type. The access status provides an indication as to whether an access request can or cannot be granted for the printing machine 1.

It will be appreciated that in some embodiments the database 5 may include additional access control information. For example, the database 5 may store records relating to previous access requests, and may store rules to be applied when determining whether to grant an access request for the printing machine 1. By way of example only, the access control server 3 may be configured to, based on the access control information for the printing machine 1, deny access requests where a previous access request has been granted in a predetermined time period. In a further alternative example, the access control information may be manually updated to indicate that access requests should or should not be granted. More generally, it will be appreciated from the above that the access control information stored in the database 5 may be maintained in any appropriate manner as dependent upon particular access control requirements.

It is determined at step S13 whether the access request should be granted. If it is determined at step S13 that access should not be granted, processing may end at step S14 with the control server 3 refusing to grant the access request. The access request may be refused based on the access control information contained in the database 5, if the identifier specified in the access request cannot be verified (e.g. if it cannot be located in the database 5), or for other reasons. By way of example only, the access control information for the printing machine 1 obtained at step S12 may indicate a set of impermissible print type(s) for the print machine 1. The access control server 3 may therefore deny any access request from the print machine 1 which requests any impermissible print type. In a further example, the access control information obtained at step S12 may indicate a maximum number of print types assigned to the print machine 1. If the print machine 1 was already granted access for executing the maximum number of print types, the access control server 3 may deny an access request from the print machine 1 which requests a further new print type. A suitable message may be generated at step S14 and provided to the user to indicate refusal to grant the access request. As described above, communication of such messages to the user may be via the printing machine 1 where it is provided with a suitable network connection, or via the user device 4.

If, on the other hand, it is determined at step S13 that the access request should be granted, processing passes to step S15 and the access control server 3 generates an access response file. The access response file includes the unique identifier of the printing machine 1 and information indicative of a granted print type. The access response file indicates that access is to be granted to printing functions of the printing machine 1 for executing the granted print type only. That is, the access response file does not allow the printing machine 1 to execute a print job of a print type other than the granted print type. Nor does the access response file grant access to a printing machine other than the printing machine 1. The granted print type is generally the same as the requested print type. It will be understood, however, that the access control server 3 may grant a print type, which is deemed as a substitute of the requested print type, if the requested print type is obsolete or otherwise unavailable.

The access response file further includes information indicative of a granted print quantity corresponding to the granted print type. The access response file may further include information specifying a time period during which access is granted. That is, the access response file is for granting the printing machine 1 an access right for printing any material which is of the granted print type within the granted print quantity. In a particular embodiment in which the printing machine 1 is a thermal transfer printer, the print quantity may advantageously be specified as a print distance (measured, for example, in lengths of ribbon). In other cases, where the printing machine 1 is, for example, an inkjet printer, the print quantity may be specified as, for example, a quantity of ink or a number of ink cartridges. Additionally, the print quantity may be specified as a number of pages to be printed, a number of print units, or the like. The print quantity granted by the access response file may not be exactly the same as the requested print quantity. In an example, a predetermined set of print quantities may be stored either in the access control server 3 or the database 5, and the access control server 3 may select one of the predetermined set of print quantities for granting to an access request based upon an algorithm. In particular, the access control server 3 may select a minimum quantity which fulfils (i.e., is equal to or greater than) the requested quantity from the predetermined set. Alternatively, the selection may be manually made by an administrator of the access control server 3. In a further example, the access control server 3 may quantize the requested print quantity to an integer multiple of a unit print quantity. The unity quantity may be stored either in the access control server 3 or the database 5, or be determined by the administrator.

The access response file may be encrypted for subsequent decryption by the controller 2. For example, the access control server 3 may encrypt the access response file using a public key of the printing machine 1/controller 2 such that only the controller 2 can decrypt the access response file. By encrypting the access request file and the access response file, reverse engineering and abuse of the access granting mechanism is made more difficult.

The access control server 3 may additionally or alternatively sign all or part of the access response file using its own private key. In this way, the printing machine 1 can verify that the access response file has been issued by the access control server 3. It is to be understood that the use of asymmetric encryption is merely exemplary and that any encryption and verification mechanisms may be used.

Processing passes to step S16 and the access control server 3 updates the access control information stored in the database 5 in response to the issuance of the access response. For example, the access control server 3 may update the access control information to reflect the granting of access rights and to create a record of the access request. In this way, the access control server 3 can deny duplicate access requests. For example, if an access request is intercepted by a third party, or if a user attempts to re-use an existing access request, this can be detected by querying the access control information stored at the database 5.

At step S17, the access response file is transmitted from the access control server 3 for provision to the printing machine 1. It will be appreciated from the above that such transmission may be to the user device 4 or directly to the printing machine 1 in dependence upon the communication functionality of the printing machine 1. Where the access response file is transmitted to the user device 4, the user may provide the access response file to the printing machine 1. For example, the user may transfer the access response file from the user device 4 to an external storage device for subsequent transfer to the printing machine 1. In an alternative example, the user may transmit the access response file from the user device 4 to the printing machine 1 via a short range transmission protocol such as Bluetooth.

Referring again to FIG. 3a, when it is determined at step S3 that an access response file has been received, processing passes to step S4 and the controller 2 processes the access response file. For example, where the access response file is encrypted, the controller 2 may attempt to decrypt the access response file. The controller 2 may also attempt to verify that the received access response file is valid and originates from the access control server 3 and/or to verify that the access response file is for the printing machine 1. For example, the access response file may be decrypted by the controller 2 and the information stored therein compared to information stored in the local non-volatile storage 2c. The comparison of the information in the access response file to stored information may include, for example, comparing a “signature” of the source of the access response file to an expected signature. Where the signature has been encrypted by the access control server 3 using its private key, for example, the controller 2 may decrypt the signature using the public key of the access control server 3 to verify that the access control server 3 is in fact the source of the access response file. The controller 2 may further verify whether the access response file includes the unique identifier of the printing machine 1, in order to determine whether the access response file is intended for the printing machine 1.

Other information may be verified at step S4. In an example where the access request file generated at step S2 includes information indicative of a print type and/or a print quantity, the controller 2 may further verify whether the requested print type and/or print quantity corresponds to the granted print type and/or the print quantity. The controller 2 may at step S4 create a record of the access response file in the local non-volatile storage 2c. In particular, the controller 2 may store the granted print type and the granted print quantity in the non-volatile storage 2c.

If it is determined, at step S5, that verification and/or decryption of the access response file is unsuccessful, processing passes to step S6 and access to the printing functions of the printing machine 1 for executing the print type requested is denied. For example, if the controller 2 has verified that the access response file does not include the unique identifier of the printing machine 1, the controller 2 will discard the access response file since it is not intended for granting access to the printing machine 1. A suitable message may be provided to the user to indicate that access to print functions of the printing machine 1 for executing the requested print type will not be granted. However, it will be understood that access to the printing functions of the printing machine 1 for printing other print types is not affected by the denial of access at the step S6.

If, on the other hand, verification of the access response file at step S5 is successful, processing passes to step S7 and access to print functions of the printing machine 1 for executing the requested print type is granted in accordance with the details specified in the access response file (such as, the time period and the granted print quantity). In an example, an access right granted by the access response file to the printing machine 1 may be independent of an identity of a user of the printing machine. That is, the access response file allows the printing machine 1 to execute print job(s) of the granted print type within the granted print quantity in total, regardless of the identity of the user from whom the print job(s) originate. If there is no access response file that ever grants access right in relation to a particular print type to the printing machine 1, then the printing machine 1 is not able to print any material of the particular print type, regardless of the identity of the user who is requesting access to the printing machine 1.

Upon successful verification of the access response file, the controller 2 may further update an access status of the printing machine 1 which is also stored in the non-volatile storage 2c, based upon the granted print type and the granted print quantity. These are described in more detail below.

FIG. 4 schematically illustrates the transfer of access request and access response data in the system of FIG. 1 whereby the user device 4 provides an intermediary between the printing machine 1 and the access control server 3. In the example of FIG. 4, an access request file 10 is generated at the printing machine 1. The access request file 10 is encrypted and signed by the printing machine 1 to generate the encrypted access request file 11. The encrypted access request file 11 is provided to the user device 4, either through manual transfer or through transmission. The encrypted access request file 11 is transmitted to the access control server 3. The encrypted access request file 11 is decrypted and verified by the access control server 3, to obtain the access request file 10. The access request file 10 is used by the access control server 3 to generate an access response file 12. The access response file 12 is encrypted and signed by the access control server 3 to generate an encrypted access response file 13. The encrypted access response file 13 is transmitted to the user device 4 and subsequently provided to the printing machine 1. The printing machine 1 decrypts the encrypted access response file 13 to obtain the access response file 12.

The access status maintained by the controller 2 and stored in the local non-volatile storage 2c may include at least one access right. The controller 2 may update such locally stored access status to be consistent with an access right granted in an access response file. FIG. 5 shows an example of the access status of the printing machine 1 locally stored within the non-volatile storage 2c. As illustrated in FIG. 5, there are four different access rights ‘01’, ‘02’, ‘03’, ‘04’ corresponding to four different print types. In this example, the print types are defined by layout templates ‘A’, ‘B’, ‘C’, ‘D’ which are used by a user to create a design of his print job. Each of the access rights ‘01’, ‘02’, ‘03’, ‘04’ further has a print quantity corresponding to the respective print type. In this example, the printing machine 1 is a thermal transfer printer, and the print quantities are defined by lengths of ribbon. It will be appreciated that upon successful verification and decryption of an access response file at steps S5 and S7 of FIG. 3a, the controller 2 will update the access rights shown in FIG. 5 according to the access response file. For example, if the access response file grants an access right having a print type of “Template B” and a print quantity of 100 metres, the access right ‘02’ will be updated to have a new print quantity of 140 metres. It will further be appreciated that details of the access rights may be stored in any appropriate form in the local non-volatile storage 2c and are not limited to the particular tabular form shown in FIG. 5.

Each access right means that the printing machine 1 is allowed to execute print job(s) of the respective print type within the respective print quantity. If a user wishes to use the printing machine 1 to execute a print job having a new print type (e.g., layout template ‘E’) which is not allowed by the access rights maintained by the controller 2, the printing machine 1 cannot successfully execute the print job. In order to execute the print job, the controller 2 must successfully obtain from the access control server 3 an access response file which grants the printing machine 1 an access right for executing the new print type, by carrying out the processing of FIG. 3a. Further, if the user wishes to execute a print job of an existing print type (e.g., layout template A) for a quantity (e.g., 50 metres) greater than the existing print quantity (i.e., 20 metres), the printing machine 1 cannot execute the print job in its entirety. The controller 2 must successfully obtain from the access control server 3 an access response file which grants the printing machine an access right for executing the existing print type within a further print quantity (i.e., at least 30 metres), by carrying out the processing of FIG. 3a.

FIG. 6 is a flowchart showing processing that may be carried out by the controller 2 in response to receiving a print request (i.e. a request to print material). In the example of FIG. 6, the printing machine 1 is taken to be a thermal transfer printer, and the access rights maintained by the controller 2 are taken to be similar to those shown in FIG. 5.

At step S20 the controller 2 receives a print request indicating material to be printed. The material to be printed may be in the form of text(s) or image(s), or a combination of text(s) and image(s). At step S21, the controller 2 determines whether the printing machine has valid access rights. In some embodiments, the processing at step S21 may determine a print type and a print quantity required by the print request, and whether the existing access rights maintained by the controller 2 are sufficient to complete the print request. The print type and/or the print quantity may be included within the print request, or may be provided to the controller 2 by a user separately from the print request. For example, a user may input his desired print type and/or print quantity via the key pad 2e of the printing machine 1. Where the printing machine 1 is a thermal transfer printer, a determination may be made as to whether the existing access rights allow for executing the print type requested and allow for a sufficient length of ribbon to fulfil the print quantity requested. It will be appreciated that details of the current access rights may be stored in any appropriate form in the local non-volatile storage 2c.

If it is determined at step S21 that there are no valid access rights for the print type requested, or that the existing access rights are insufficient to fulfil the print quantity requested, processing ends at step S22 and the print request is denied. At step S22, the user may be provided with an option to indicate whether he wishes to request access to the printing function of the printing machine 1 in order to complete the print request. If the user's response is positive, the controller 2 will proceed to generate a new access request file for transmission to the access control server 3, as shown in step S2 of FIG. 3a. The controller 2 will further proceed to carry out the processing specified at steps S3 to S7 of FIG. 3a. The new access request file may be transmitted from the controller 2, either directly to the access control server 3 or via any further intermediate device (such as the user device 4 as described above). As described above in relation to step S2 of FIG. 3a, the new access request file may not include information indicative of a requested print type and/or a requested print quantity. In that case, the requested print type and/or the requested print quantity may be provided by the user via the user device 4 directly to the access control server 3, or may be provided manually by the user to an administrator of the access control server 3. That is, the user can freely select the requested print type and/or the requested print quantity according to his needs. Alternatively, the new access request file may include information indicative of the request print type (i.e., the print type of the print request obtained at step S20). The new access request file may include further information indicative of the requested print quantity. The requested print quantity may be a standard quantity or may be determined by the controller 2 based upon a difference between the print quantity requested by the print request and the quantity permitted by the existing access rights.

On the other hand, if it is determined at step S21 that the access rights are currently valid and sufficient, processing passes to step S23 and the print request is executed (i.e. requested material is printed).

Processing passes to step S24 at which the print quantity used in executing the print request is determined. In the example where the print quantity is measured in lengths of ribbon, determining the length of ribbon used in executing the print request may be by any suitable method as will be apparent to the skilled person. For example, a length of ribbon may be calculated based on a line-density of ink on the ribbon, a line-density of the material to be printed and/or a detection of ribbon throughput.

Processing passes to step S25 at which the access rights stored in the local non-volatile storage 2c are updated in response to the execution of the print request. For example, if the print request is of a print type of “Template A” and a print quantity of 15 metres, the “print quantity” data item of the access right ‘01’ as shown in FIG. 5 is reduced to 5 metres to reflect the length of ribbon used in executing the print request.

As described above, it will be understood that the print types and the print quantities shown in FIG. 5 may be defined by other parameters. In an example, the print type is defined by a print width of each print unit, and the print quantity may be defined by a number of print units. Therefore, at step S21 of FIG. 6, a determination may be made as to whether the existing access rights allow for printing the particular print width and completing the number of print units required by the print request received at S20, while at step S25 to update the access rights stored in the local non-volatile storage 2c, the number of units actually printed is deducted from the “print quantity” data item of FIG. 5 corresponding to the print width. In another example where the printing machine 1 is an inkjet printer, the print type may be defined by a type of ink to be used, and the print quantity may be measured in quantities of ink provided in one or more ink cartridges. Accordingly, at step S21 of FIG. 5, a determination may be made as to whether the existing access rights allow for a requested type of ink with a sufficient quantity of ink to be used to complete the print request, while at step S25 to update the access rights stored in the local non-volatile storage 2c the “print quantity” data item of FIG. 5 corresponding to the requested type of ink may be reduced to reflect the quantity of ink used in executing the print request.

As described above, each access response file generated at step S15 of FIG. 3b grants the printing machine 1 an access right for executing print job(s) of a print type within a print quantity specified in the access response file. The printing machine 1 may be able to execute print job(s) of a plurality of different print types. It is known that executing pint job(s) of different print types typically require different resources, such as, different types or quantities of print consumables. The print consumables may take any suitable form depending upon a type of the printing machine 1. For example, where the printing machine 1 is a thermal transfer printer, the print consumables may be ribbons. Ribbons have a plurality of types defined by, for example, ribbon widths and/or ribbon colours. An amount of print consumables (e.g., ribbons) may be measured in suitable units, such as, length of ribbons, or roll of ribbons. Where the printing machine 1 is an inkjet printer, the print consumables may be ink and/or substrate. Ink is generally classified into a plurality of types defined by, for example, ink properties (e.g., viscosity, conductivity, etc.) and/or ink colours. An amount of print consumable (e.g., ink) may be measured in suitable units, such as, volume of ink, or number of ink cartridges.

Each type or quantity of print consumable may correspond to a respective print type and be most suitable for use in printing materials of the corresponding print type. Whilst it may be possible to use a particular type or quantity of print consumable, which is most suitable for printing a first print type, to print a second different print type, this however may reduce the operational efficiency of the printing machine 1, the use efficiency of the particular print consumables, and may waste resources such as energy. Use of incorrect print consumables or incorrect use of print consumables may additionally result in wastage, having a negative environmental effect.

By performing the access control processing described above with reference to FIGS. 3a and 3b, the printing machine 1 may be restricted to executing print types which are granted by the access control server 3. In an example, the printing machine 1 is granted access right for executing print job(s) of the first print type only and has not been granted access right for executing print job(s) of the second print type; as a result, the particular type or quantity of print consumables available to the printing machine 1, which is most suitable for printing the first print type, are inhibited from being used by the printing machine 1 to execute print job(s) of the second print type. In this way, the efficiencies of the printing machine 1 and the print consumables are both improved.

The print request received by the controller 2 at step S20 may be based upon a print file generated by the print file control server 6 as illustrated in FIG. 7.

Processing performed by the print file control server 6 is now described. At step S30, the print file control server 6 receives an indication of material to be printed. The material to be printed may be in the form of text(s) or image(s), or a combination of text(s) and image(s). The material to be printed may be generated at the print file control server 6. In particular, the material may be generated by an application which runs on the print file control server 6 but is operated remotely by a user at the user device 4. That is, the application may be a web-based application.

At step S31, the print file control server 6 determines a print type of the material to be printed. By way of example only, if the user generates the material to be printed using a particular layout template provided by the web-based application, the print type may be indicative of the particular layout template, and the print file control server 6 may accordingly determine the print type of the material to be the particular layout template being used. In another example, the print file control server 6 estimates a print width of the material to be printed and sets the estimated print width as the print type of the material to be printed. The print width may be estimated by the print file control server 6 in any suitable way, such as, for example, based upon a number of characters included in the material to be printed and/or a font size used in the material if the material is text-based. Alternatively, the web-based application of the print file control server 6 may display an indication of an active area for a user to design the material to be printed. The material to be printed may have a width which is only a part of an overall width of the active area. Accordingly, the print width may be estimated by the print file control server 6 based upon a ratio of the width of the material to the overall width of the active area. Alternatively, the web-based application may display a plurality of standard areas, whereby a print type is determined based upon a number of standard areas taken up by the material to be printed. For example, if the material to be printed occupies (or fits within) a single standard area, the material to be printed may be assigned to a first print type, while if the material to be printed occupies two standard areas, the material to be printed may be assigned to a second print type.

Processing passes to step S32 and the print file control server 6 generates a print file. The print file includes the material to be printed and information indicative of the print type of the material. The print file may further include information indicative of a print quantity of the material to be printed, if the web-based application of the print file control server 6 allows the user to indicate his desired print quantity. The print file control server 6 may transmit the generated print file to the user device 4 via, for example, the internet. The user device 4 may forward the print file to the controller 2 of the printing machine 1 if the user wishes to print the material included in the print file. In the event that the printing machine 1 and the user device 4 are not directly connected to each other, the user may download the print file from the user device to a USB flash drive and subsequently connect the USB flash drive to the I/O port 2f of the controller 2 in order to provide the print file to the controller 2. In the event that the print file generated by the print file control server 6 does not include information indicative of a print quantity of the material, the user may be prompted by the printing machine 1 to input the print quantity via, for example, the key pad 2e. In any event, the print file generated at step S32 of FIG. 7 may form at least a part of a print request for receipt by the controller 2 at step S20 of FIG. 6. The controller 2 subsequently carries out the processing shown in FIG. 6 to process the print request.

It will be understood that in order to successfully print the material contained within the print file generated at step S32, it is necessary to ensure that the printing machine 1 has available print consumables, apart from having sufficient access right as described above, that are suitable for executing the print type of the material and are sufficient for fulfilling the print quantity of the material. For a printing machine which is capable of executing print jobs of different print types, e.g., the printing machine 1, understocking of print consumables may increase down time and reduce the efficiency of the printing machine 1. Overstocking is not ideal either, since print consumables typically have limited shelf life and may have to be discarded if they are not used within a time period. Discarded print consumables increase the risks of polluting the environment.

To mitigate these problems, the print file control server 6 may automatically generate print consumables request data for processing by the access control server 3 (or to another server, such as a dedicated print consumables server). That is, the print file control server 6 may use the print consumables request data to request suitable print consumables on behalf of the printing machine 1.

The print consumables request data may include information of the printing machine 1, such as but not limited to, the unique identifier of the printing machine 1 or a geographical location (e.g. an address) of the printing machine 1. The identification information of the printing machine 1 may be used by the access control server 3 to determine a destination of requested print consumables.

The print consumables request data includes information indicative of a type of print consumable for provision to the printing machine 1. The type and/or quantity of print consumable indicated by the print consumables request data may correspond to the print type of the material contained within the print file. That is, print consumables of the indicated type may be those most suitable for executing the print type of the material.

The information indicative of a type of print consumable may include identification information of a type of print consumable (such as, ribbon widths and/or ribbon colours). In particular, the print file control server 6 may determine a type of print consumable most suitable executing the print type of the material. The determination may be based upon, for example, information stored in a memory accessible by the print file control server 6.

Alternatively, the information indicative of a type of print consumable may include the print type of the material. Accordingly, upon receiving the print consumables request data, the access control server 3 will determine the type of print consumable that corresponds to the print type of the material for provision to the printing machine 1.

In this way, the print consumables request data can be used to automatically order print consumables of a correct type suitable for use by the printing machine to execute the material contained within the print file. The ordering of print consumables is therefore automated and does not require any user intervention.

The print consumables request data may also include information indicative of an amount of the print consumable for provision to the printing machine 1. The amount of print consumables may be determined by the print file control server 6 based upon the print quantity of the material together with the print type of the material. For example, where print quantity is expressed in terms of a number of print units, a single print unit may require different lengths of ribbon.

By way of example only, the print file control server 6 may determine an amount of a print consumable required for executing the print quantity in its entirety, and the determination may be by any suitable method as will be apparent to the skilled person. For example, for a thermal transfer printer, if the print quantity is measured in, for example, number of print units, the print file control server 6 may calculate an amount of print consumables required (e.g., a length of ribbon or roll(s) of ribbon) based upon the print quantity (i.e., the number of print units), a print type which may include a length of ribbon required for printing each print unit of the print type, and a spacing between adjacent print units. In an embodiment, the length of ribbon required for printing each print unit may be determined by the print file control server 6 based upon a length of the print unit. The spacing between adjacent print units may be a fixed value stored in a memory accessible by the print file control server 6. It will however be appreciated that the amount of print consumables may be measured in the same unit as the print quantity, e.g., both in lengths of ribbons. If so, the print file control server 6 determines the required amount of print consumables as being equal to the print quantity. The amount of print consumables indicated by the print consumables request data may be equal to or greater than the determined amount of print consumables required for executing the print quantity in its entirety.

Alternatively, the print consumables request data may not include information indicative of a desired amount of print consumables, if print consumables are generally supplied to the printing machine 1 in a fixed amount (e.g., a single roll of ribbon or a single ink cartridge) every time.

The access control server 3 receives the print consumables request data transmitted from the print file control server 6, and processes the print consumables request data to determine whether the requested print consumables should be supplied to the printing machine 1. The database 5 may, for example, store print consumables control information. The print consumables control information may take any suitable format and provides an indication as to whether the requested print consumables should be supplied to the printing machine 1. Alternatively, the access control server 3 may use the access control information contained in the database 5 to determine whether the requested print consumables should be supplied to the printing machine 1. As described above, the access control information includes records of access rights granted to the printing machine 1. If, for example, the print consumables request data relates to a particular print type which is not included within any access right granted to the printing machine 1, the access control server 3 may determine that the requested print consumables will not be supplied to the printing machine 1.

Upon determining that the requested print consumables should be supplied to the printing machine 1, the access control server 3 will proceed to authorise a shipping of print consumables to the printing machine 1, the print consumables being of a type and/or an amount as indicated by the print consumables request data. The authorisation signal may be transmitted to, for example, an administrator of the access control server 3, who will then arrange the shipping of the authorised print consumables.

It will be appreciated that the print file generated by the print file control server 6 at step S32 is likely to be executed by the printing machine 1 in the near future. Therefore, by arranging the print file control server 6 to transmit print consumables request data to the access control server 3 for ordering print consumables corresponding to the print type and the print quantity of the material contained within the print file, the inventory of print consumables available to the printing machine 1 is synchronised with the print file and significant overstocking or understocking of print consumables is therefore avoided. Accordingly, the efficiency of the printing machine 1 is improved and risk of pollution caused by overstocked print consumables is reduced.

In an example, the print file control server 6 generates print consumables request data for processing by the access control server 3, in response to each print file generated at step S32. It will be understood that this is merely exemplary. For example, if the amount of print consumables supplied to the printing machine 1 every time is fixed, such as a single roll of ribbon or a single ink cartridge, the print file control server 6 may generate print consumables request data for processing by the access control server 3 in response to the generation of an initial print file containing material of a print type. If, after the generation of subsequent print files containing material of the same print type, the print file control server 6 determines that the print files require insignificant print quantities compared to the remaining amount of print consumables ordered previously, the print file control server 6 may not generate print consumables request data for processing by the access control server 3.

In a further example, the print file control server 6 may only generate print consumables request data if a print file generated at step S32 is of a particular print type and the print file control server 6 determines that the remaining amount of print consumables most suitable executing the particular print type and available to the printing machine 1 is lower than a threshold. Determining the remaining amount of print consumables available to the printing machine 1 may be by any suitable method as will be apparent to the skilled person. For example, the print file control server 6 may maintain a running total of an amount of a particular print consumable available to the printing machine 1 based upon an amount of that print consumable sent to the printing machine 1 and information contained in granted print requests.

In another example, the print file control server 6 may estimate a consumption rate of print consumables of a particular type used by the printing machine 1, based upon print files containing material of a print type corresponding to the particular type of print consumables that are generated by the print file control server 6 with a time period. In particular, based upon those print files, the print file control server 6 may estimate a total amount of print consumables of the particular type required within the time period. With the consumption rate, the print file control server 6 may generate print consumables request data including information indicative of the particular type of print consumables periodically, so as to make sure that print consumables of the particular type are maintained at a healthy level at the printing machine 1.

It is to be understood that the processing described above with reference to FIGS. 3 to 7 is merely exemplary. For example, while it is described above with reference to FIG. 6 that a print request is denied where there are insufficient print quantity corresponding to the requested print type to complete the print request, in an alternative example embodiment, the user may be provided with the option to complete a part of the print request to the extent possible with the currently access rights, and the user may be provided with a further option to indicate whether he wishes to request access to the printing functions of the printing machine 1 in order to complete the print request. If the user's responses are positive, the printing machine 1 will execute a part of the print request using the existing access rights and will proceed to generate a new access request file for transmission to the access control server 3 in order to execute the remaining part of the print request, as described above in relation to step S2 of FIG. 3a and step S22 of FIG. 6. Other modifications to the exemplary processing described above will be readily apparent to the skilled person in light of the foregoing.

Similarly, it will be appreciated that the arrangement of FIG. 1 is merely exemplary. For example, while the database 5 is depicted as being local to the access control server 3, it will be appreciated that in other embodiments the database 5 may be remote to the access control server 3 and accessibly via suitable connections. Similarly, while it is described above that the control server 3 maintains the access control information in the database 5, in other embodiments such maintenance may be performed by a different computing device and may be performed by a third party. For example, in some embodiments the printing machine 1 may be provided to a user by a distributor and communication between the user/printing machine 1/user device 4 and the access control server 3 may be via computing devices of the distributor. In such an embodiment, the access control information stored at the database 5 may include information about to the distributor. For example, a decision as to whether to grant access to printing functions of the printing machine 1 may be based upon characteristics of the distributor in addition to, or instead of, characteristics of the user or of the printing machine 1. As described above, the access control server 3 is used to process the access request file transmitted from the printing machine 1 and the print consumables request data transmitted from the print file control server 6. It will be understood that two different servers may be used to separately process the access request file and the print consumables request data. Further, it will be appreciated that although the access control server 3 and the print file control server 6 are illustrated separately in FIG. 1, the access control server 3 and the print file control server 6 may not be two separate servers, but instead may be two modules running on a single server.

Various features of the printing machine have been described above. In some cases, exemplary components, configurations and methods suitable for realising these particular features have been described. However in many cases the skilled person will know of other components, configurations and methods which can similarly be used to realise the particular features which are described. Many of these components, configurations and methods will be known to the skilled person from the common general knowledge. It is envisaged that such alternative components, configurations and methods can be implemented in the described embodiments without difficulty given the disclosure presented herein.

While references have been made herein to a controller or controllers it will be appreciated that control functionality described herein can be provided by one or more controllers. Such controllers can take any suitable form. For example control may be provided by one or more appropriately programmed microprocessors (having associated storage for program code, such storage including volatile and/or non-volatile storage). Alternatively or additionally control may be provided by other control hardware such as, but not limited to, application specific integrated circuits (ASICs) and/or one or more appropriately configured field programmable gate arrays (FPGAs). While various embodiments of printing machine(s) have been described herein, it will be appreciated that this description is in all respects illustrative, not restrictive. Various modifications will be apparent to the skilled person without departing from the spirit and scope of the invention.

1. A printing machine comprising:
a processor;
a memory storing computer readable instructions arranged to cause the processor to:
generate access request data for processing by an access control server;
receive access response data responsive to the access request data;
process the access response data to determine a first print type and a first print quantity indicated by the access response data; and
update, responsive to processing the access response data, an access status in the memory to indicate a second print quantity for the first print type.

2. The printing machine of claim 1, wherein the first print type is at least one of a layout template, a print width, a number of character(s) contained within a print unit, or a type of ink.

3. The printing machine of claim 1, wherein the first print quantity is at least one of a print distance, a length of ribbon, a number of pages, a number of print units, or a quantity of ink.

4. The printing machine of claim 1, wherein the access request data comprises information indicative of a second print type.

5. The printing machine of claim 1, wherein the computer readable instructions are arranged to cause the processor to encrypt and/or cryptographically sign the access request data.

6. The printing machine of claim 1, wherein the computer readable instructions are arranged to cause the processor to include a unique identifier of the printing machine in the access request data.

7. The printing machine of claim 6, wherein the computer readable instructions are arranged to cause the processor to process the access response data to verify that the access response data includes the unique identifier of the printing machine.

8. The printing machine of claim 7, wherein the access response data is for granting the printing machine an access right for printing any material having the first print type within the first print quantity.

9. The printing machine of claim 8, wherein the access right granted to the printing machine by the access response data is independent of an identity of a user of the printing machine.

10. The printing machine of claim 7, wherein in response to the processor verifying that the access response data does not include the unique identifier of the printing machine, the computer readable instructions are arranged to cause the processor to discard the access response data without updating the access status in the memory.

11. The printing machine of claim 1, wherein to process the access response data, the computer readable instructions are arranged to cause the processor to verify that the access response data originates at the access control server.

12. The printing machine of claim 1, wherein the computer readable instructions are arranged to cause the processor to update the access status from indicating a third print quantity for the first print type to indicate the second print quantity for the first print type.

13. The printing machine of claim 1, wherein the computer readable instructions are arranged to cause the processor to:
receive a print request indicating material to be printed;
determine a print type and a print quantity of the print request, and
determine, based upon the access status stored in the memory, whether the print request can be executed in its entirety.

14. The printing machine of claim 13, wherein in response to determine that the print request cannot be executed in its entirety, the computer readable instructions are arranged to cause the processor to generate a further access request data for processing by the access control server.

15. The printing machine of claim 13, wherein to determine whether the print request can be executed in its entirety, the computer readable instructions are arranged to cause the processor to:
determine whether the access status stored in the memory comprises a first access status corresponding to the print type of the print request.

16. The printing machine of claim 15, wherein the computer readable instructions are arranged to cause the processor to:
in response to determining that the access status stored in the memory comprises the first access status, compare a fourth print quantity corresponding to the first access status with the print quantity of the print request.

17. The printing machine of claim 13, wherein in response to determine that the print request cannot be executed in its entirety, the computer readable instructions are arranged to cause the processor to deny the print request.

18. The printing machine of claim 13, wherein the computer readable instructions are arranged to cause the processor to print only a part of the material to be printed, the part being determined based upon the access status.

19. The printing machine of claim 18, wherein the instructions are arranged to cause the processor to update the access status to indicate a new print quantity corresponding to the print type of the print request in response to printing only a part of the material.

20. The printing machine of claim 13, wherein the access status stored in the memory comprises a further access status corresponding to another print type which is different from the print type of the print request, and the computer readable instructions are arranged to cause the processor to determine whether the print request can be executed in its entity, independently of the further access status.

21. The printing machine of claim 1, wherein the printing machine is a thermal transfer printer.

22-37. (canceled)

38. A method for controlling access to a printing function of a printing machine, comprising, at the printing machine:
generating access request data for processing by an access control server;
receiving access response data responsive to the access request data;
processing the access response data to determine a first print type and a first print quantity indicated by the access response data; and
updating, responsive to processing the access response data, an access status in the memory to indicate a second print quantity for the first print type.

39. A computer readable medium carrying computer readable instructions arranged to cause a processor to carry out the method of claim 38.

40. A method for generating a print file for provision to a printing machine, comprising:
receiving an indication of material to be printed;
determining a print type of the material to be printed; and
generating a print file for provision to the printing machine, the generated print file comprising the material to be printed and information indicative of the print type of the material to be printed.

41. The method of claim 40, further comprising:
generating a print consumables request data based on the print type and an indication of a print quantity associated with the print type; and
providing the print consumables request data to a server.

42. The method of claim 41, further comprising processing the print consumables request data by the server to automatically order print consumables for the printing machine.

43. A computer readable medium carrying computer readable instructions arranged to cause a processor to carry out the method of claim 40.
